(19) United States
(12) Patent Application Publication
(10) Pub. No.: US 2010/0016163 A1
(43) Pub. Date: Jan. 21, 2010

(54) Adjuvant and dispersant formulations for pesticidal applications

(75) Inventors: Jason Scott Keiper, Greensboro, NC (US); Timothy Mark Figley, Hoffman Estates, IL (US); Andrew David Malec, Chicago, IL (US); Krista L. Turpin, Loganville, GA (US); Franz J. Luxem, Palatine, IL (US)

Correspondence Address: DILWORTH IP, LLC, 2 CORPORATE DRIVE, SUITE 206, TRUMBULL, CT, 06611, US

(73) Assignee: Stepan Company, Northfield, CT (US)

(21) Appl. No.: 12/462,975

(22) Filed: Aug. 12, 2009

Related U.S. Application Data
(63) Continuation of application No. PCT/US2008/055041, filed on Feb. 26, 2008.
(60) Provisional application No. 60/891,643, filed on Feb. 26, 2007.

(51) Int. Cl. A01N 57/18; A01N 25/00; A01P 3/00; A01P 7/04; A01P 13/00; A01N 37/34; A01N 43/40; A01N 43/653; A01N 53/02

(52) U.S. Cl. 504/206; 514/788; 504/358; 514/784; 514/785; 514/777; 514/772.1; 514/525; 514/341; 514/383; 514/531

(57) ABSTRACT

There is provided is an adjuvant/dispersant for pesticide formulations (among other formulated uses) comprising at least one dialkyl alkanolamine such as dimethyl ethanolamine, at least one derivative thereof, or a combination thereof. Pesticide compositions comprising a pesticide, such as glyphosate, and the adjuvant/dispersant of the present technology and methods for enhancing the effectiveness of the pesticide, such as glyphosate, in an aqueous composition through the addition of the adjuvant/dispersant of the present technology are also disclosed. Solid pesticidal formulations comprising a pesticidal active ingredient and the adjuvant/dispersant of the present technology are also provided.

### RELATED APPLICATIONS

This application claims priority to International Application PCT/US2008/055041, with an international filing date of Feb. 26, 2008, published in English under PCT Article 21(2), which claims priority to U.S. Provisional Application Ser. No. 60/891,643, filed Feb. 26, 2007 and PCT Application No. PCT/US07/81805 filed Oct. 18, 2007, the contents of which are incorporated by reference in their entireties.

### BACKGROUND OF THE INVENTION

The presently described technology relates generally to adjuvants, dispersants, and methods of using the same for enhancing the efficacy of pesticides and other end use products and applications. More particularly, the presently described technology relates generally to adjuvants and/dispersants comprising at least one dialkyl alkanolamine, at least one derivative thereof, or a combination thereof, and one or more methods of enhancing the effectiveness of pesticides (herbicides, insecticides, fungicides, among others) such as glyphosate, a derivative thereof, or a mixture thereof, chlorothalonil, a derivative thereof, or a mixture thereof, and imidacloprid, a derivative thereof, or a mixture thereof in an aqueous composition through the addition of the adjuvants and/or dispersants of the present technology. In addition, the presently described technology relates generally to dispersants comprising at least one dialkyl alkanolamine, at least one derivative thereof, or a combination thereof in formulating a variety of delivery systems such as wettable powders and suspension concentrates, that can include a variety of agents, for example pesticidal active ingredients. Moreover, the presently described technology relates generally to surfactants comprising at least one dialkyl alkanolamine, at least one derivative thereof, or a combination thereof in formulating emulsifiable concentrates (among others), such as those that can include pesticidal active ingredients as well as other ingredients.

Glyphosate is well known in the art as an effective post-emergent foliar-applied herbicide. In its acid form, glyphosate has a structure represented by the following formula:

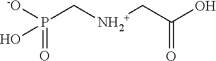

Glyphosate is relatively insoluble in water (1.16% by weight at 25° C.). For this reason it is typically formulated as a water-soluble salt.

Glyphosate salts include monobasic, dibasic and tribasic salts. However, it is generally preferred to formulate glyphosate and apply glyphosate to plants in the form of a monobasic salt. Various salts of glyphosate, methods for preparing salts of glyphosate, formulations of glyphosate or its salts and methods of use of glyphosate or its salts for killing and controlling weeds and other plants are well known in the art, and are disclosed in, for example, U.S. Pat. Nos. 5,998,332, 5,994,269, 5,196,044, 4,507,250 to Bakel, 4,481,026 to Prisbylla, 4,405,531 to Franz, 4,315,765 to Large, 4,140,513 to Prill, 3,977,860 to Franz, 3,853,530 to Franz, and 3,799,758 to Franz. The aforementioned patents are incorporated herein in their entirety by reference.

The most widely used salt of glyphosate is the mono(isopropylammonium) salt, often abbreviated to IPA salt. Commercial herbicides having the IPA salt of glyphosate as an active ingredient of are available under the trade names Roundup®, Roundup® Ultra, Roundup® UltraMax, Roundup® Xtra and Rodeo® from Monsanto Company, St. Louis, Mo. All of these commercial herbicides are aqueous solution concentrate (SL) formulations and are generally diluted in water by a user prior to application to plant foliage. For economic reasons, it is advantageous to package and sell post-emergent herbicides in concentrate formulations which have low or no solvent content. In addition to concentrate formulations, IPA salt herbicidal formulations are also commercially available to home owners in so-called “ready-to-use” (RTU) forms, which can be sprayed on targeted weeds directly by a home owner.

Other glyphosate salts that have been commercially formulated as SL formulations include the mono(trimethylsulfonium) salt, often abbreviated to TMS salt, used for example in Touchdown® herbicide of Syngenta Crop Protection, Greensboro, N.C. Another water soluble salt of glyphosate that is of particular interest and being commercialized recently is the potassium salt, having a structure represented by the following formula:

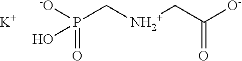

Like many post-emergent herbicides, glyphosate and salts thereof are generally slow acting. Such slow responses of targeted weeds to the herbicidal compositions often fail to provide the desired phytotoxicity of the formulation for days, sometimes even weeks. This is undesirable from a user's standpoint, especially for home and garden users where the herbicide is used for aesthetic purposes by the users.

Other known pesticides include, for example, chlorothalonil, imidacloprid, chlorpyrifos, tebuconazole, and bifenthrin.

Over the years, developments have focused on alternative formulations containing one or more adjuvants that can enhance pesticidal efficacy in tank mix compositions and improve the rapidity of response to pesticide formulations. For example, D. J. Turner reported in Butterworths (1985), at pages 229-230, that 2% concentrations of polycarboxylic acids in glyphosate (e.g., Roundup®) tank mixes gave efficacy enhancement. For another example, Research Disclosure publication number RD15334, Industrial Opportunities Ltd., Homewell-Havant-Hampshire P09 1EF, United Kingdom (January 1977), disclosed that glyphosate tank mixes formulated with water containing calcium and/or magnesium ions in concentrations greater than 200 ppm (hard water) had diminished herbicidal activity as a pesticide. Allegedly, herbicidal activity could be restored by adding oxalic acid to the tank mix in weight ratios to glyphosate of between about 1:10 to about 10:1.

U.S. Pat. No. 5,863,863 to Hasabe et al. discloses tank mix formulations comprising about 0.08% glyphosate acid equivalent (a.e.) by weight (wt % a.e.) of IPA glyphosate and about 0.001 moles/l of dipotassium, disodium, diammonium, diethanolamine or dimethylamine oxalate, and an ethoxylated tertiary amine or quaternary ammonium surfactant. Concentrate compositions containing about 41 wt % a.e. of IPA glyphosate and 0.21 moles/kg of dipotassium, disodium, diammonium, diethanolamine or dimethylamine oxalate are also described.

U.S. Pat. Nos. 5,849,663 and 6,008,158 to Hasabe et al. disclose tank mix formulations containing IPA glyphosate or TMS glyphosate at 0.08 wt % a.e., polycarboxylic acid salt chelating agents including oxalate salts at 0.02 wt %, and ethoxylated tertiary amine and quaternary ammonium surfactants. Hasabe reports polycarboxylic acid to surfactant weight ratios between about 1:2 and about 1:9 with efficacy enhancement resulting from complexation of metal ions.

U.S. Pat. No. 6,093,679 to Azuma et al. discloses tank mixes containing 0.38 wt % TMS glyphosate (available as Touchdown®), 0.53 wt % hydroxycarboxylic acid-based chelating agents, including potassium oxalate, and a quaternary ammonium surfactant having an alkoxylated carboxy alkyl anion.

U.S. Pat. No. 6,218,336 to Coleman discloses tank mixes containing up to 1.25 wt % Roundup® Ultra IPA glyphosate and 2.5 wt % of succinic, tartaric or malic acids or their ammonium salts. Sylgard 309® (ethoxylated organosilicone) and Emsorb 6900® (polyoxyethylenated sorbitol ester) surfactants may be added to the tank mixes.

U.S. Pat. No. 5,948,421 to Okano et al. describes aqueous concentrate formulations containing 42 wt % and 51 wt %, respectively of the diammonium or isopropylamine salts of glyphosate, dicarboxylic acid chelating agents including potassium oxalate at 8 wt %, and an ethoxylated quaternary ammonium surfactant.

Those skilled in the art and persons familiar with the field of the presently described technology understand that the choice of a surfactant has a major bearing on pesticidal performance. However, beyond some broad generalizations, the relative ability of different surfactants to enhance the pesticidal effectiveness of pesticides is highly unpredictable. For example, in an extensive study reported in Weed Science, 1977, volume 25, pages 275-287, Wyrill and Burnside found wide variation among surfactants in their ability to enhance the herbicidal efficacy of glyphosate, applied as the IPA salt.

A number of surfactants suitable to be used as an adjuvant for potassium glyphosate formulations are disclosed in U.S. Pat. No. 7,049,270 to Lennon et al. Allegedly, surfactants tending to give the most useful enhancement of glyphosate herbicidal effectiveness are generally, but not exclusively, cationic surfactants, including surfactants which form cations in aqueous solution or dispersion at pH levels of around 4-5, characteristic of SL formulations of monobasic salts of glyphosate. Examples are long-chain (typically C₁₂ to C₁₈) tertiary alkylamine surfactants and quaternary alkylammonium surfactants. An especially common tertiary alkylamine surfactant used in aqueous solution concentrate formulations of glyphosate IPA salt has been the very hydrophilic surfactant polyoxyethylene (15) tallow amine, i.e., tallow amine having in total about 15 moles of ethylene oxide in two polymerized ethylene oxide chains attached to the amine group as shown in the following formula:

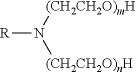

wherein R is a mixture of predominantly C₁₆ and C₁₈ alkyl and alkenyl chains derived from tallow and the total of m+n is an average number of about 15.

For certain applications, it has been found desirable to use a somewhat less hydrophilic alkylamine surfactant, such as one having less than about 10 moles of ethylene oxide, as suggested in U.S. Pat. No. 5,668,085 to Forbes et al., for example polyoxyethylene (2) cocoamine. The '085 patent generally discloses illustrative aqueous compositions comprising such a surfactant together with the IPA, ammonium or potassium salts of glyphosate. The highest concentration of glyphosate in the potassium salt formulations shown in Table 3 of U.S. Pat. No. 5,668,085 is 300 g glyphosate a.e./l, with a weight ratio of glyphosate a.e. to surfactant of 2:1.

A class of alkoxylated alkylamines is disclosed in WO 00/59302 for use in herbicidal spray compositions. Potassium glyphosate solutions including various Jeffamine™ EO/PO propylamines or propyldiamines are described therein.

A wide variety of quaternary ammonium surfactants have been disclosed as components of aqueous solution concentrate formulations of glyphosate IPA salt. Illustrative examples are N-methylpolyoxyethylene (2) cocoammonium chloride, disclosed in European Patent No. 0274369; N-methylpolyoxyethylene (15) cocoammonium chloride, disclosed in U.S. Pat. No. 5,317,003; and various quaternary ammonium compounds having the following formula:

(R¹)(R²)(R³)N⁺—CH₂CH₂O—(CH₂CH(CH₃)O)ₙHCl⁻

where R¹, R² and R³ are each C₁₋₃ alkyl groups and n is an average number from 2 to 20, disclosed in U.S. Pat. No. 5,464,807.

PCT Publication No. WO 97/16969 discloses aqueous solution concentrate compositions of glyphosate, in the form of the IPA, methylammonium and diammonium salts, comprising a quaternary ammonium surfactant and an acid salt of a primary, secondary or tertiary alkylamine compound.

Other cationic surfactants which have been indicated as useful in aqueous solution concentrate compositions of glyphosate salts include those disclosed in PCT Publication No. WO 95/33379. It is further disclosed in PCT Publication No. WO 97/32476 that highly concentrated aqueous compositions of glyphosate salts can be made with certain of these same cationic surfactants, with the further addition of a defined component that enhances stability of the compositions. Glyphosate salts exemplified therein are the IPA salt and the mono- and diammonium salts.

A class of alkyl etheramine, alkylether ammonium salt and alkyl etheramine oxide surfactants has been disclosed in U.S. Pat. No. 5,750,468 to be suitable for preparation of aqueous solution concentrate formulations of various glyphosate salts. It is disclosed therein that an advantage of the subject surfactants when used in an aqueous composition with glyphosate salts is that these surfactants permit the glyphosate concentration of the composition to be increased to very high levels.

Anionic surfactants, except in combination with cationic surfactants as disclosed in U.S. Pat. No. 5,389,598 and U.S. Pat. No. 5,703,015, are generally of little interest in SL formulations of glyphosate IPA salt. U.S. Pat. No. 5,703,015 discloses a surfactant blend of a dialkoxylated alkylamine and an anionic eye irritancy reducing compound. The surfactant blend is disclosed as being suitable for preparation of aqueous solution concentrate formulations of various glyphosate salts, the potassium salt being included in the list of salts mentioned. Concentrates of U.S. Pat. No. 5,703,015 allegedly contain from about 5% to about 50%, preferably about 35% to about 45% glyphosate acid equivalent (a.e.) by weight (wt % a.e.) and from about 5% to about 25% by weight surfactant. Further, PCT Publication No. WO 00/08927 discloses the use of certain polyalkoxylated phosphate esters in combination with certain polyalkoxylated amidoamines in glyphosate containing formulations.

Nonionic surfactants are generally reported to be less effective in enhancing herbicidal activity than cationic or amphoteric surfactants when used as the sole surfactant component of SL formulations of glyphosate IPA salt; exceptions appear to include certain alkyl polyglucosides, as disclosed for example in Australian Patent No. 627503, and polyoxyethylene (10-100) C₁₆₋₂₂ alkylethers, as disclosed in PCT Publication No. WO 98/17109. Other nonionic surfactants are generally mixed with cationic surfactants to form a compatible surfactant system for use in liquid herbicidal concentrates. However, cationic/nonionic surfactant systems generally do not provide acceptable low temperature storage stability. Concentrates containing these surfactant systems can crystallize at temperatures at or below about 0° C., limiting the use of such concentrates in cold climates.

Glyphosate concentrates containing nonionic alkylether and certain cationic amine surfactants are described in U.S. Pat. No. 6,245,713 to Brinker et al. The surfactant mixture is said to enhance biological effectiveness of the glyphosate and provide enhanced rainfastness. Suitable glyphosates for use in the concentrates include sodium, potassium, ammonium, dimethylammonium, IPA, monoethanolammonium and TMS glyphosate salts.

It has been found that some of the most effective enhancement agents, while compatible with IPA glyphosate at dilute concentrations, are not capable of being dissolved in concentrated IPA glyphosate solutions and therefore do not offer a practical solution to manufacturers for concentrated forms of glyphosate salts. Therefore, recent developments have focused on storage-stable aqueous glyphosate concentrate formulations containing adjuvants that are compatible with the glyphosate salts in the glyphosate formulations. By “storage-stable,” in the context of an aqueous concentrate composition of glyphosate salt further containing an adjuvant, is meant not exhibiting phase separation on exposure to temperatures up to at least about 50° C., and preferably not forming crystals of glyphosate or salt thereof on exposure to a temperature of about 0° C., for a period of up to at least about 7 days (i.e., the composition must have a crystallization point of 0° C. or lower). An adjuvant compatible with a glyphosate salt at specified surfactant and glyphosate acid equivalent (a.e.) concentrations is one that can provide a storage-stable aqueous concentrate composition containing that surfactant and salt at the specified concentrations.

U.S. Pat. No. 6,992,045 to Xu, et al. discloses pesticide compositions, especially storage-stable herbicidal concentrates, containing oxalic acid and glyphosate that allegedly exhibit enhanced efficacy due to the addition of oxalic acid that increases cell membrane permeability, suppresses oxidative burst, or increases expression of hydroxyproline-rich glycoproteins. This patent also discloses that a variety of surfactants including amines, amine oxides and quaternary ammonium compounds can be used in combination with oxalic acid for its pesticide compositions.

WO 06/096480 (Falcon Lab LLC, Wilmington, Del.) discloses the use of an ammonium salt of a fatty acid as an adjuvant in IPA glyphosate formulations to enhance their efficacy. It alleges that a storage-stable herbicidal concentrate of at least one glyphosate di-salt and at least one adjuvant may be prepared by adjusting the pH of a concentrate containing the glyphosate mono-salt and the adjuvant until a single-phase solution is obtained.

There is a continued need in the industry for more effective and compatible adjuvants, dispersants, and surfactants, especially those utilized in delivery formulations for pesticidal components, among others. For example, there are many commercial and other advantages to increase the efficacy of glyphosate formulations. Higher efficacy affords lower application rates of the herbicide to achieve the same degree of weed control. Application of less herbicide is cost effective to the consumer since less product can provide equivalent weed control. Moreover, such an enhanced efficacy formulation is environmentally friendly because packaged volume is reduced, less storage space is required, shipping cost savings may be realized, and most importantly, environmental burden is minimized.

Further, solid pesticidal formulations can be made by blending one or more solid pesticidal active ingredients, dispersants, and wetting agents, among other possible ingredients. For example, wettable powders formulations typically include a powdered pesticidal active ingredient, a dispersant, a wetting agent, and one or more fillers or carriers such as silica, clay, or diatomaceous earth to give the proper application rate of active ingredient and to aid in processing the formulation. Wettable powders have an average particle size of 1-50 micrometers.

As another example, suspension concentrates, like wettable powders have an average particle size of 1-50 micrometers. Typically, suspension concentrate formulations include a powdered solid active ingredient; a dispersant, wetting agent, a freeze recovery agent such as propylene glycol, an anti-settling agent such as cellulose derivatives, natural gums, or other polysaccharides, and water.

Dispersants and wetting agents used in currently available commercial pesticidal wettable powders and suspension concentrates are anionic or nonionic in nature, whereas commercial cationic dispersants and wetting agents for use in are believed to be unknown.

A good dispersant will have molecular properties that achieve two functions: first, the molecules need to adsorb strongly to a solid active ingredient particle, and second, the molecules must provide some electrostatic or steric barrier relative to another active ingredient particle. These two properties ensure that the active ingredient particles do not flocculate and then settle out of suspension. Many dispersants are anionic, aromatic molecules, such as sodium lignosulfonates or sodium naphthalene sulfonate formaldehyde condensate, that adsorb onto the small particle surfaces to prevent the particles from flocculating or aggregating together. The aromatic group provides a polarizable aspect to the molecule that allows for efficient adsorption to the solid particle surfaces via induced dipole-charge interactions, the charge interaction coming from the negative charge that most solid particles possess in water. For example, the most common dispersants used today are sodium naphthalene sulfonate formaldehyde condensate, sodium lignosulfonate, and tristyrylphenol ethoxylates. All of these molecules have some aromatic chemical structure that are, due to the polarizable nature of the aromatic groups, able to strongly adsorb to solid surfaces. For example, the two sulfonates mentioned above are both charged and provide electrostatic barriers to flocculation. The tristyrylphenol ethoxylates are quite bulky and provide steric barriers to flocculation. Sodium lignosulfonate is both charged and bulky, providing both steric and electrostatic barriers to flocculation.

Because most solid particles are slightly negatively charged in water, there is a potential for true charge-charge interaction if a dispersant were positively charged. Charge-charge interactions are typically 100-1000 times stronger than an induced dipole-charge interaction. This stronger interaction can enhance the efficiency of the dispersant.

Along with a dispersant, a separate wetting agent is typically used in solid formulations. Some wetting agents used in solid pesticidal formulations include sodium lauryl sulfate, alcohol ethoxylates, or nonyl phenol ethoxylates to lower the interfacial tension of the active ingredient particle/water interface. Lowering this interfacial tension allows the small solid particles to be wetted and mixed with the water in the spray tank easily. Efficient wetting agents are better at spreading the solid particles throughout the suspension, increasing stability and performance of the pesticidal formulation. The use of a dispersant and a separate wetting agent, however, only adds to the complexity and processing of solid pesticidal formulations.

Thus, it would be advantageous to develop a cationic dispersant that can provide both dispersant and wetting agent properties to be used in solid formulations, such as wettable or dry powders, suspension concentrates, and emulsifiable concentrates. It would also be advantageous to develop dispersant compositions and/or formulations containing such dispersants with similar properties that could enhance the effects of the active ingredients of those formulations. As will be clear from the disclosure that follows, these and other benefits can be provided by the presently described technology.

### BRIEF SUMMARY OF THE INVENTION

The presently described technology relates generally to one or more adjuvants, dispersants, and formulations containing such components as well as methods of using the same for enhancement of the pesticidal efficacy of pesticides. The adjuvants/dispersants of the present technology comprise at least one dialkyl alkanolamine, at least one derivative thereof, or a combination thereof. It has been surprisingly found that the pesticidal effectiveness of pesticides, such as glyphosate, a derivative thereof, or a mixture thereof in an aqueous composition can be unexpectedly enhanced through the addition of the adjuvant/dispersant of the present technology. One preferred dialkyl dialkanolamine is dimethyl ethanolamine, and the adjuvant/dispersant preferably comprises at least one quaternary derivative of dimethyl ethanolamine. The adjuvant/dispersant of the present technology can be provided to a user after having been mixed with a pesticide or a mixture of pesticides. Alternatively, it can be provided to a user as, for example, a tank mix adjuvant either by itself or in a tank mix adjuvant/dispersant composition.

In one aspect, the present technology provides a treatment composition for application to a biological entity to elicit a biological effect. The treatment composition comprises a biologically effective amount of a pesticide or a mixture of pesticides comprising, for example, glyphosate, a derivative thereof, or a mixture thereof and an adjuvant including dialkyl alkanolamines, derivatives thereof, or combinations thereof. The adjuvant is present in a concentration such that the pesticidal efficacy of the treatment composition is enhanced as compared to a reference treatment composition devoid of the adjuvant but otherwise having the same composition as the treatment composition of the present technology. The pesticide (or mixture of pesticides) and the adjuvant of the present technology can be premixed before the treatment composition is provided to a user. Alternatively, in accordance with at least one embodiment, the plant treatment composition can be prepared in situ by mixing the pesticide, the adjuvant, and other optional ingredients including water by a user.

The pesticide or mixture of pesticides can include, for example, an herbicide, a fungicide, or an insecticide, derivatives thereof, or mixtures thereof. Examples of pesticides include glyphosate, chlorothalonil, imidacloprid, tebuconazole, chlorpyrifos, and bifenthrin, derivatives thereof, or mixtures thereof.

Examples of derivatives of dialkyl alkanolamines include, but are not limited to, quaternized dialkyl alkanolamines (e.g., dimethyl alkyl ethanol quaternary ammonium compounds), and esteramines and esterquats derived from dialkyl alkanolamines and carboxylic acids (e.g., fatty acids). In at least one preferred embodiment, the adjuvant comprises at least one quaternary derivative of dimethyl ethanolamine, which can be a quaternized dimethyl ethanolamine, an esterquat derived from dimethyl ethanolamine and a fatty acid, or a mixture thereof.

In another aspect, the presently described technology provides an aqueous pesticidal concentrate composition that comprises a pesticide, a derivative thereof, or a mixture thereof in a concentration in excess of 200 grams of active pesticidal ingredient per liter of the concentrate composition; and an adjuvant selected from the group including, for example, dialkyl alkanolamines, derivatives thereof, and combinations thereof. The pesticide can be, for example, glyphosate, a derivative thereof, or a mixture thereof in a concentration in excess of 200 grams glyphosate a.e. per liter of the composition. The adjuvant is present in a concentration such that, when the concentrate composition is diluted in a suitable volume of water to form an application mixture and applied, the uptake of the, for example, glyphosate, the derivative thereof, or the mixture thereof is increased in the biological entity treated with said application mixture as compared to a biological entity treated with a reference application mixture devoid of the adjuvant, but otherwise having the same composition as the application mixture of the present technology.

In a further aspect, the present technology provides a method for enhancing the efficacy of a treatment composition for application to a biological entity to elicit a biological effect. The method comprises: providing a pesticide composition comprising a pesticide or a mixture of pesticides comprising, for example, glyphosate, a derivative thereof, or a mixture thereof in a biologically effective amount; providing an effective amount of an adjuvant including, for example, dialkyl alkanolamines, derivatives thereof, or combinations thereof; and preparing a treatment composition comprising the pesticide composition and the adjuvant. It has been unexpectedly found that growth of a plant treated with a composition containing the adjuvant of the present technology is limited to a greater extent as compared to a plant treated with a reference plant treatment composition devoid of the adjuvant, but otherwise having the same composition as the plant treatment composition of the present technology.

In another aspect, the present technology provides a wettable powder composition comprising one or more active pesticidal ingredients, and one or more dispersants including, for example, dialkyl alkanolamines, derivatives thereof, or combinations thereof, and combinations thereof. The one or more active pesticidal ingredients can present from about 20 to about 90 weight percent, while the one or more dispersants can be present from about 1 to about 20 weight percent in the overall composition.

In another aspect, the present technology provides a suspension concentrate composition comprising one or more active pesticidal ingredients; one or more dispersants including, for example, dialkyl alkanolamines, derivatives thereof, or combinations thereof; and water. The one or more active pesticidal ingredients can present from about 20 to about 60 weight percent, while the one or more dispersants can be present from about 1 to about 20 weight percent in the overall composition. The composition can optionally include one or more additives, for example, a freeze recovery agent or an anti-settling agent. The balance of the composition can be water.

In yet another aspect, the present technology provides an emulsifiable concentrate composition comprising one or more active pesticidal ingredients; a first surfactant including, for example, dialkyl alkanolamines, derivatives thereof, or combinations thereof; and a solvent. The one or more active pesticidal ingredients can present from about 20 to about 60 weight percent, while the first surfactant can be present from about 1 to about 20 weight percent. The composition can optionally include at least one second surfactant or other additives. The balance of the composition is a solvent, such as Aromatic 150, Hallcomid M-8-10 (containing from about 50 to about 65% N,N-dimethyloctanamide, from about 37 to about 50% of N,N-dimethyldecanamide, from about 0 to about 5% N,N-dimethylhexanamide, and from about 0 to about 2% N,N-dimethyldodecanamide) available from Stepan Company, Northfield, Ill., and methyl esters, etc.

### BRIEF DESCRIPTION OF SEVERAL VIEWS OF THE DRAWINGS

FIG. 1 shows the Gibbs Isotherms of the C14 DMEA esterquats and Makon TSP-25.

FIG. 2 shows the dynamic surface tension profile for C14 DMEA esterquats.

FIG. 3 shows the Gibbs Isotherm plots for the C14 DMEA MeCl Esterquat of the presently described technology made in Example 1 and a comparative C14 DMAPA MeCl Esterquat made in Example 2.

### DETAILED DESCRIPTION OF THE INVENTION

It has been surprisingly found that dialkyl alkanolamines such as dimethyl ethanolamine, derivatives thereof, and mixtures thereof exhibit unexpected properties when they are used as adjuvants or dispersants for a variety of components, in particular pesticides such as glyphosate or derivatives thereof. Examples of derivatives of dialkyl alkanolamines include, for example, quaternized dialkyl alkanolamines (e.g., dimethyl alkyl ethanol quaternary ammonium compounds), and esteramines and esterquats derived from dialkyl alkanolamines and carboxylic acids (e.g., fatty acids). In particular, the quaternary derivatives of dimethyl ethanolamine, which can be dimethyl alkyl ethanol quaternary ammonium compounds and esterquats derived from dimethyl ethanolamine and fatty acids have been found to be very effective over a wide range of formulated concentrations.

One example of such quaternary derivatives is an esterquat derived from dimethyl ethanolamine and myristic acid, which can have the following molecular structure:

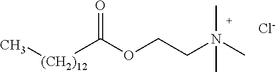

A typical procedure to prepare some of the amine derivatives of the present technology is shown in the exemplary reaction Scheme 1 below.

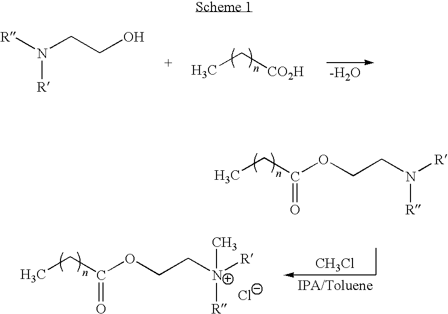

A dialkyl ethanolamine is used in this exemplary Scheme 1. The two alkyl groups R′ and R″ are independently selected, each of which preferably contains from about 1 to about 23, alternatively from about 1 to about 12 carbon atoms, alternatively from about 1 to about 4 carbon atoms. Other dialkyl alkanolamines containing a different alkanol group can also be used in the present technology, and whose derivatives can similarly be produced in accordance with Scheme 1 shown above. Preferably, the alkanol group contains from about 1 to about 23 carbon atoms, alternatively from about 1 to about 12 carbon atoms, alternatively from about 1 to about 4 carbon atoms. In accordance with at least some embodiments, dimethyl ethanolamine is the preferred alkanolamine to make the adjuvants of the present technology.

The carboxylic acid used can have a carbon chain of one carbon atom or more (n=0, 1, 2, . . . ). Preferably, the carboxylic acid is a mono-carboxylic acid. Also preferably, the carboxylic acid is a fatty acid having a saturated or unsaturated carbon chain of from about 5 to about 23 carbon atoms, alternatively from about 8 to about 18 carbon atoms, alternatively from about 8 to about 14 carbon atoms. The fatty acid can be derived from a variety of feedstocks such as lard, tallow, canola, castor, coconut, corn, cottonseed, olive, palm, peanut, rapeseed, safflower, sesame, soybean, sunflower, and tung.

Derivatives of carboxylic acids, preferably, fatty acid derivatives can also be used. Examples of suitable derivatives include, for example, esters such as methyl esters, anhydrides, acid chlorides, and glycerol esters of carboxylic acids. Derivatives of carboxylic acids such as fatty acid derivatives can be used alone or in combination with each other and/or with free fatty acids. One preferred fatty acid for at least some embodiments of the present technology is myristic acid, methyl ester thereof, or a combination thereof.

As shown in Scheme 1, a dialkyl ethanolamine, preferably, dimethyl ethanolamine can first be mixed with a fatty acid with a desired chain length (e.g., myristic acid) at a mol ratio of from about 1:1 to about 5:1, alternatively from about 1:1 to about 3:1, alternatively from about 1:1 to about 2:1 (e.g., about 1.1 or 1.2 mol equivalent). The mixture can then be reacted in the presence of a catalyst such as dibutyl tin oxide, and optionally, an azeotroping agent such as toluene, at a temperature sufficient to complete the reaction. The reaction temperature is preferably between about 75° C. and about 250° C., alternatively between about 150° C. to about 225° C., alternatively between about 175° C. and about 200° C. The process is typically complete when the residual acid number is less than about 20 mgKOH/g, alternatively less than about 10 mgKOH/g, alternatively less than about 5 mgKOH/g. The resulting derivative is an esteramine.

A person skilled in and familiar with the art will understand that in the above reaction, care should be taken to avoid large losses of the amine during the heating process. This can be accomplished by, for example, (1) careful ramping of the temperature, (2) using a large amine alcohol excess to drive the reaction, followed by removal of excess amine reagent, or (3) using provisions such as a rectification column.

Quaternization of the esteramine produced in Scheme 1 can be accomplished by quaternization processes known in the art. For example, as shown in Scheme 1, the esteramine product can react with an appropriate quaternizing agent, e.g., methyl chloride (MeCl) or dimethyl sulfate (DMS), at a temperature within the range of from about 50° C. to about 150° C., alternatively from about 70° C. and 110° C., alternatively from about 80° C. to about 90° C. and at about 10 psig to about 200 psig, alternatively about 30 psig to about 40 psig. Preferably, the esteramine product is diluted with an appropriate solvent, e.g., isopropyl alcohol (IPA), propylene glycol, glycerol, toluene, or a mixture thereof, until the concentration of the esteramine product is about, for example, 60 wt % in the solvent. A suitable amount (e.g., from about 1 to about 1.1 equivalents) of the quaternizing agent can then be added under proper conditions (e.g., dropwise for DMS or under pressure for MeCl) to quaternize the esteramine in the solvent. The resulting esterquat, which is a quaternary amine, can then be filtered and washed.

Besides esterquats, quaternized dialkyl alkanolamines can also be used as the adjuvants/dispersants of the present technology, either alone or in combination with dialkyl alkanolamines or other derivatives thereof. Quaternization of dialkyl alkanolamines can be accomplished by any quaternization process known in the art.

Preferably the quaternizing agents used to quaternize the alkanolamines or esteramines of the present technology can provide an alkyl group having from about 1 to about 23, alternatively from about 1 to about 12, alternatively from about 1 to about 4, alternatively from about 1 to about 2 carbon atoms.

The adjuvant/dispersant of the present technology can be provided to a user after having been premixed with a pesticide or a mixture of pesticides. Alternatively, the adjuvant/dispersant can be provided to a user either by itself or in a tank mix adjuvant/dispersant composition, for example.

In accordance with some embodiments, the present technology provides treatment compositions, e.g., herbicidal, fungicidal, and insecticidal compositions (among others), for application to a biological entity to elicit a biological effect, that comprise a biologically effective amount of at least one pesticide and at least one adjuvant of the present technology. The adjuvant/dispersant of the present technology includes, for example, dialkyl alkanolamines, derivatives thereof, or combinations thereof. As described above, derivatives of dialkyl alkanolamines include, for example, quaternized dialkyl alkanolamines, esteramines derived from dialkyl alkanolamines, and esterquats derived from dialkyl alkanolamines. Preferably, the adjuvant/dispersant comprises a quaternized dialkyl alkanolamine and/or an esterquat derived from a dialkyl alkanolamine. One preferred example of the dialkyl alkanolamine is dimethyl ethanolamine. The concentration of the adjuvant/dispersant of the present technology in the treatment composition is such that the efficacy of the treatment composition is enhanced as compared to a reference treatment composition devoid of the adjuvant/dispersant, but otherwise having the same composition as the treatment composition of the present technology.

In accordance with at least one embodiment, the treatment composition comprising the pesticide and adjuvant/dispersant of the present technology is provided to a user as a premix. In accordance with at least another embodiment, the treatment composition is prepared by the user in situ, and the adjuvant is added as a tank mix adjuvant, either by itself or in combination with other tank mix additives.

It has been surprisingly found that the class of compounds of the presently described technology, which can be dialkyl alkanolamines, derivatives thereof, or combinations thereof, exhibit a lower surface tension on, for example, plant leaves, and perform unexpectedly well as adjuvants/dispersants for pesticides, including, for example, water-soluble herbicides. Without intending to be bound by any particular theory, it is believed that this class of compounds can further reduce the surface tension of the pesticides on the biological entities (e.g., plant leaves), and thus enhance the activity and effectiveness of the pesticides. Further, without being bound by any particular theory, it is believed that the uptake of the pesticide can be increased by the adjuvant in the biological entity treated with a treatment composition of the present technology as compared to a biological entity treated with a reference treatment composition devoid of the adjuvant/dispersant, but otherwise having the same composition as the treatment composition of the present technology.

The class of compounds of the presently described technology can be blended with other suitable compounds such as other surfactants, growth regulators, fillers or processing aids, anti-settling agents, freeze recovery agents, and/or hormones in an adjuvant formulation for pesticides. Such surfactants include, for example, amine oxide surfactants, phosphate ester surfactants, ether sulfate surfactants, alkyl amine ethoxylates, alkyl poly glycosides, alcohol ethoxylates, other non-ionic surfactants, alkyl quaternary ammonium surfactants, carboxylic acids (e.g., citric acid), ammonium sulfates, ether amine ethoxylates, alkyl betaines, and combinations thereof. Examples of plant growth regulators or hormones include, but are not limited to, auxins, cytokinins, and gibberellins.

The presently described technology is not limited to any particular class of pesticides. A composition of the presently described technology can comprise a pesticide or a mixture of pesticides. The pesticide or mixture of pesticides can include an herbicide, fungicide, insecticide, etc.

A preferred group of pesticides are herbicides that are normally applied post-emergence to the foliage of plants. Examples of herbicides suitable for use in compositions of the present technology include acifluorfen, acrolein, amitrole, asulam, benazolin, bentazon, bialaphos, bromacil, bromoxynil, chloramben, chloroacetic acid, clopyralid, 2,4-D, 2,4-DB, dalapon, dicamba, dichlorprop, difenzoquat, diquat, endothall, fenac, fenoxaprop, flamprop, flumiclorac, fluoroglycofen, flupropanate, fomesafen, fosamine, glufosinate, glyphosate, imazameth, imazamethabenz, imazamox, imazapic, imazapyr, imazaquin, imazethapyr, ioxynil, MCPA, MCPB, mecoprop, methylarsonic acid, naptalam, nonanoic acid, paraquat, picloram, quinclorac, sulfamic acid, 2,3,6-TBA, TCA, triclopyr, chlormequat chloride water-soluble salts thereof, and combinations thereof.

An especially preferred herbicide useful in a composition of the present technology is glyphosate, the acid form of which is alternatively known as N-(phosphonomethyl)glycine. Glyphosate, derivatives thereof (e.g., esters or salts thereof), and combinations thereof can all be used in the plant treatment compositions of the present technology, either by themselves or in combination with other pesticides. Because glyphosate in its acid form is relatively insoluble in water (about 1.16% by weight at 25° C.), the glyphosate component in at least some plant treatment compositions of the present technology is substantially in a water-soluble salt form. Glyphosate salts useful in the compositions of the present technology and the methods to make the same are known in the art. Glyphosate salts that can be used according to some embodiments of the present technology include, but are not limited to, alkali metal, for example sodium and potassium, salts; ammonium salt; C₁₋₆ alkylammonium, for example dimethylammonium and isopropylammonium, salts; C₁₋₆ alkanolammonium, for example monoethanolammonium, salt; C₁₋₆ alkylsulfonium, for example trimethylsulfonium, salts; and mixtures thereof. The N-phosphonomethylglycine molecule has three acid sites having different pKa values; accordingly mono-, di- and tribasic salts, or any mixture thereof, or salts of any intermediate level of neutralization, can be used.

For some plant treatment compositions of the present technology, preferred glyphosate salts include the potassium salt, isopropylamine salt, ammonium salt, diammonium salt, monoethanolamine salt, and trimethylsulfonium salt. More preferred glyphosate salts include potassium, monoammonium, diammonium, sodium, monoethanolamine, isopropylamine, n-propylamine, ethylamine, ethylenediamine, hexamethylenediamine and trimethylsulfonium salts, and combinations thereof. Even more preferred glyphosate salts include potassium, monoammonium, diammonium, sodium, monoethanolamine, n-propylamine, ethylamine, ethylenediamine, and hexamethylenediamine salts, and combination thereof. Most preferred glyphosate salts include potassium, monoammonium, diammonium, and monoethanolamine salts, and combinations thereof.

Examples of fungicides suitable for use in compositions of the present technology include chlorothalonil, tebuconazole, ethanethiol, benomyl, binapacryl, bupirimate, captafol, chinomethionate, dinocap, mancozeb, iprodione, metalaxyl, meterim, propineb, pyrazophos, triadimefon, tridemorph, triforine, zineb. Examples of insecticides suitable for use in composition of the present technology include imidacloprid, chlorpyrifos, bifenthrin, azinphosmethyl, carbaryl, carbofuran, chinomethionate, dichlorvos, dicofol, dieldrin, endosulfan, fenitrothion, fensulfothion, fenthion, omethoate, oxydemetonmethyl, phenamiphos, phosphamidon, pirimiphos methyl, deltamethrin, cypermethrin, penvalerate, decamethrin, trichlorphon, rotenone, malathion, dimethoate, and diazinon.

In accordance with some embodiments of the present technology, the treatment composition can be a concentrate composition, which can be diluted in a suitable volume of water to form an application mixture (e.g., a tank mix) for applying to the foliage of a susceptible plant, or other biological entity. The concentrate composition can be in liquid, solid, or semi-solid form. In at least one preferred embodiment, it is an aqueous concentrate composition.

For example, when glyphosate is used as the post-emergent pesticide or one of the post-emergent pesticides in the concentrate composition, the amount of the glyphosate herbicide in the concentrate composition can be from about 10 wt % to about 80 wt %, alternatively from about 16 wt % to about 60 wt %, alternatively from 35 wt % to about 55 wt %. The amount of the dialkyl alkanolamine adjuvant in the concentrate composition may typically be from about 0 to about 15 weight percent, alternatively between from about 1 to about 7 weight percent, alternatively from about 3 to about 5 weight percent.

The concentrate composition can be diluted by a user to render an application mixture containing from about 0 to about 15 weight percent, alternatively from about 0 to about 5 weight percent, alternatively from about 0.2 to about 2 weight percent of the glyphosate herbicide. The application mixture can typically contain from about 0 to about 3 weight percent, alternatively from about 0 to about 1 weight percent, alternatively from about 0.1 to about 0.5 weight percent of the dialkyl alkanolamine adjuvant of the present technology.

For some applications, users of liquid pesticidal products meter the dosage by volume rather than by weight, and such products are thus usually labeled with directions for suitable use rates expressed in volume per unit area, e.g., liters per hectare (l/ha) or fluid ounces per acre (oz/acre). Thus the concentration of pesticidal active ingredient that matters to the user often is not percent by weight, but weight per unit volume, e.g., grams per liter (g/l) or pounds per gallon (lb/gal). In the case of glyphosate salts, concentration is often expressed as grams of acid equivalent per liter (g a.e./l).

Historically, surfactant-containing glyphosate IPA salt products such as Roundups® and Roundup® Ultra herbicides from Monsanto Company have most commonly been formulated at a glyphosate concentration of about 360 g a.e./l. The surfactant-containing glyphosate TMS salt product Touchdown® of Syngenta has been formulated at a glyphosate concentration of about 330 g a.e./l. Products at lower a.e. concentration, i.e., more dilute, are also sold in some markets, but carry a cost penalty per unit of glyphosate they contain, primarily reflecting packaging, shipping and warehousing costs.

Further benefits in cost savings and in convenience to the user are possible if a “fully loaded” aqueous concentrate composition, or at least one having an agronomically useful surfactant content, can be provided at a glyphosate concentration of at least about 320 g a.e./l, 340 g a.e./l, or significantly more than 360 g a.e./l, for example at least about 420 g a.e./l or more, or at least 440, 450, 460, 470, 480, 490, 500, 510, 520, 530, 540, 550, 560, 570, 580, 590, 660 g a.e./l or more. In accordance with at least some embodiments of the present technology, the concentrated composition with such high glyphosate concentration still has a cloud point of at least about 50° C. and a crystallization point not greater than about 2° C., preferably not greater than about 0° C.

In accordance with some embodiments, the presently described technology provides a method for killing or controlling pests comprising the steps of diluting a concentrate composition of the present technology in a suitable amount of water to form a tank mix and applying a pesticidally effective amount of the tank mix to the biological entity, such as the foliage of the weeds or unwanted vegetation.

In accordance with some other embodiments of the present technology, the treatment composition is in a “ready-to-use” (RTU) composition. The RTU composition can be prepared by a user by diluting a concentrate composition as described above, or alternatively can be provided to the user as is. Preferably, the RTU composition, when sprayed on a targeted biological entity, can cause the entity to die in short time periods, more preferably as short as 24 hours or less. For example, when the glyphosate herbicide is used, the RTU composition can contain from about 0.5 to about 5%, alternatively from about 0.75% to about 3%, alternatively from about 1.5% to about 2.5%, by weight of the glyphosate herbicide. The RTU composition can contain from about 0 to about 2.5%, alternatively from about 0.2% to about 2%, alternatively from about 0.5 to about 1%, by weight of the adjuvant of the present technology. The balance of the formulation can be other active ingredients, such as surfactants and water.

Alternatively, in accordance with some embodiments, a RTU composition or tank mix of the present application can be prepared in situ by (1) adding the adjuvant into a commercial RTU composition without the adjuvant of the present technology, or (2) mixing the adjuvant, a concentrate pesticide composition, water, and other additional ingredients. In these embodiments, the adjuvant of the present technology can be provided to the user, for example, as a tank mix adjuvant or in a tank mix adjuvant composition comprising other tank mix additives.

The treatment compositions or tank mix adjuvant compositions of the present technology can include other ingredients or additives that are commonly included in pesticide formulations or known in the art. For example, some embodiments of the treatment compositions or tank mix adjuvant compositions of the present technology can include surfactants that can reduce or mitigate irritation of the quaternary ammonium compounds in the compositions of the present technology. Such surfactants can be referred to as irritation mitigators, and can be amine oxide surfactants, phosphate ester surfactants, ether sulfate surfactants, betaines, citric acid, chelating agents such as EDTA, and combinations thereof. Other ingredients, additives or “tank mix” additives include surfactants or other compounds that can reduce viscosity, increase stability, and/or increase flowability of the plant treatment compositions of the present technology, especially when they are in concentrate (e.g., high active glyphosate) forms.

Other suitable tank mix additives include, but are not limited to, polycarboxylic acids, polycarboxylic acid salt chelating agents including oxalate salts, calcium and/or magnesium ion concentrations with added oxalic acid, ethoxylated tertiary amines, quaternary ammonium surfactants with or without an alkoxylated carboxyl alkyl anion, hydrocarboxylic acid based chelating agents such as potassium oxalate. Examples of oxalate salts include dipotassium, disodium, diammonium, diethanolamine and dimethylamine oxalates. Additional examples of tank mix additives include succinic, tartaric or malic acids or their ammonium salts, polyoxyethylene (15) tallow amine, polyoxyethylene (2) cocoamide, alkoxylated alkylamines, propylamines, propyldiamines, N-methylpolyoxyethylene (2) cocoammonium chloride, N-methylpolyoxyethylene (15) cocoammonium chloride, alkyl etheramine, alkylether ammonium salt, and alkyl etheramine oxide.

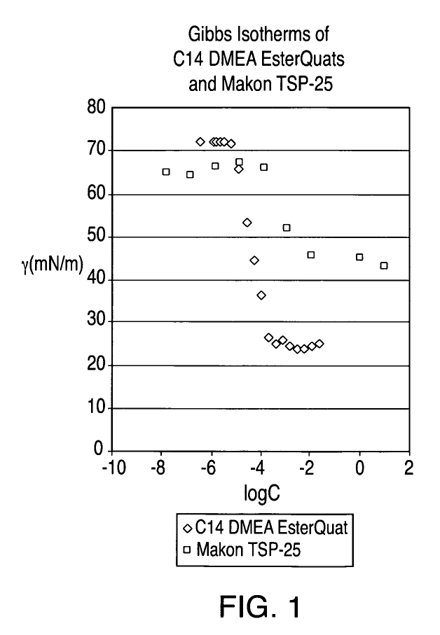

In other embodiments, the present technology can act as a dispersant and a wetting agent in compositions, such as solid pesticidal formulations. This dual performing nature of the present technology is generally unknown in the art. Use of the present technology can provide a unique simplification to solid pesticidal formulations that provide advantages over the traditional combination of dispersants and wetting agents. In some embodiments, the use of the present technology to take the place of a dispersant and a wetting agent improves processing efficiency without compromising the performance of the solid formulation. FIG. 1, which depicts the Gibbs Isotherms of the C14 DMEA esterquat described above and Makon TSP-25, a tristyrylphenol ethoxylate (commonly used as a dispersant) commercially available from Stepan Company, Northfield, Ill., shows that the C14 DMEA esterquat is dispersant than Makon TSP-25.

A wettable powder formulation of the present technology can include one or more powdered solid active ingredients; one or more dispersants including, for example, dialkyl alkanolamines, such as diethyl ethanolamine, derivatives thereof, or mixtures thereof; and any inert fillers, processing aids, or other additives. For example, a wettable powder formulation can include from about 20 to about 90 weight percent of a active pesticidal ingredient, such as chlorothalonil, a derivative thereof, or a mixture thereof and from about 1 to about 20 weight percent of an esterquat derived from dimethyl ethanolamine and myristic acid, with the remainder being any inert fillers, such as silica, clay, or diatomaceous earth. In an alternative embodiment, the present technology can be used to formulate dry powders having one or more powdered solid active ingredients; one or more dispersants including, for example, dialkyl alkanolamines, such as diethyl ethanolamine, derivatives thereof, or mixtures thereof; and any inert fillers, processing aids, or other additives.

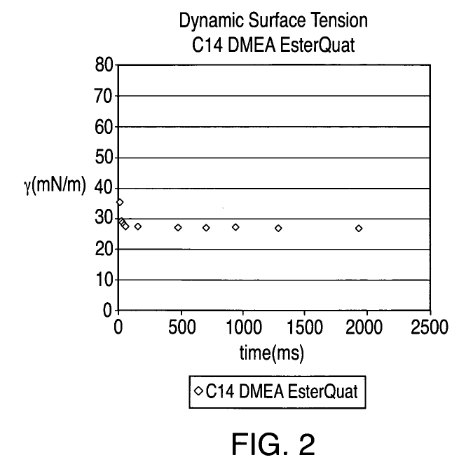

It has been surprisingly found that the dialkyl alkanolamines, such as dimethyl ethanolamine, derivatives thereof, and mixtures thereof, are unique in that the technology can provide both dispersant and wetting properties to wettable powder formulations. C14 DMEA esterquats, for example, have good wetting properties, as shown by the dynamic surface tension profile in FIG. 2. It is believed that these wetting properties of the present technology can provide enhanced wetting of the small particles enabling the powder to suspend easily in the water in the pesticidal spray tank. Furthermore, the majority of solid particles have a residual negative charge in water. Without intending to be bound to any particular theory, it is believed that the cationic charge of the present technology would be not only strongly adsorbed, but would also be bound by electrostatics to the surface of the solid particles. In some embodiments, the fatty acid chains of the present technology can provide a steric barrier to flocculation of the particles. Further modifications of the fatty acid part of the present technology can add to their performance as a dispersant.

A suspension concentrate formulation of the present technology can include one or more powdered solid active ingredients; one or more dispersants including dialkyl alkanolamines, such as dimethyl ethanolamine, derivatives thereof, or mixtures thereof; and water. The suspension concentrate can also include a freeze recovery agent, an anti-settling agent, and other additives. For example, a suspension concentrate formulation can include from about 20 to about 60 weight percent of a active pesticidal ingredient, such as chlorothalonil, a derivative thereof, or a mixture thereof and from about 1 to about 20 weight percent of an esterquat derived from dimethyl ethanolamine and myristic acid, with the remainder being water and any freeze recovery agent (such as propylene glycol) and any anti-settling agent (such as cellulose derivatives, natural gums, or other polysaccharides).

It has been unexpectedly found that the dialkyl alkanolamines, such as dimethyl ethanolamine, derivatives thereof, and mixtures thereof, are unique in that the technology can provide both dispersant and wetting properties to delivery systems, such as suspension concentrate formulations.

In other embodiments, the present technology can act as a surfactant used as an emulsifier in an emulsifiable concentrate. An emulsifiable concentrate formulation of the present technology can include one or more powdered solid active ingredients; one or more dispersants including dialkyl alkanolamines, such as dimethyl ethanolamine, derivatives thereof, or mixtures thereof; and solvent. For example, an emulsifiable concentrate formulation can include from about 15 to about 60 weight percent of a active pesticidal ingredient, such as tebuconazole, a derivative thereof, or a mixture thereof and from about 1 to about 20 weight percent of an esterquat derived from dimethyl ethanolamine and myristic acid, with the remainder being solvent, such as Hallcomid M-8-10 (containing 50-65% N,N-dimethyloctanamide, 37-50% of N,N-dimethyldecanamide, 0-5% N,N-dimethylhexanamide, and 0-2% N,N-dimethyldodecanamide), which is commercially available from Stepan Company, Northfield, Ill. The emulsifiable concentrate formulation can also include other surfactants/emulsifiers, such as one or more of Toximul 8320 (a butyl based block copolymer), Ninex MT-630 (fatty acid ethoxylate), and Ninate 60E (calcium dodecyl benzene sulfonate).

The presently described technology and its advantages will be better understood by reference to the following examples. These examples are provided to describe specific embodiments of the present technology. By providing these specific examples, the applicants do not limit the scope and spirit of the present technology. It will be understood by those skilled in the art that the full scope of the presently described technology encompasses the subject matter defined by the claims appending this specification, and any alterations, modifications, or equivalents of those claims.

### EXAMPLES

### Example 1

### Preparation of an Esterquat from Myristic Acid and Dimethyl Ethanolamine

An esterquat of the present technology was prepared from myristic acid (CH₃(CH₂)₁₂COOH), dimethyl ethanolamine (DMEA), and MeCl in this example. The esterquat will be referred to as “C14 DMEA MeCl Esterquat.”

More specifically, about 1753.64 grams of myristic acid and about 1370.61 grams of DMEA were added to a 5 L 4-neck round bottom flask equipped with a mechanical stirrer, nitrogen sparge, a 5-plate Oldershaw column condenser with a temperature gauge. This mixture was then heated to about 140° C. for approximately five hours and the reaction progress was checked via fatty acid titration. The reaction mixture was then heated slowly to about 175° C. to complete the reaction. The resulting product is an esteramine and can be referred to as C14 DMEA Esteramine.

About 1054.2 grams the C14 DMEA Esteramine and about 529.3 grams of propylene glycol were then added to a 4 L 4-neck pressure vessel equipped with thermocouple and nitrogen purging. The vessel was then purged and vented with nitrogen three times and the system was heated to about 80° C. Then MeCl was charged to the vessel at a pressure of about 40 psig. The reaction progress was monitored by perchloric acid titration, total chloride titration, and an HCl titration. About 173.8 grams of MeCl was added in total. The quaternization product was C14 DMEA MeCl Esterquat.

About 189.9 grams of propylene glycol was added to the reaction product to achieve a final actives level of C14 DMEA MeCl Esterquat in propylene glycol of about 60.14%.

### Example 2

### Preparation of a Comparative Esterquat from Methyl Myristate and Dimethyl Amino Propyl Amine

A comparative esterquat was prepared from dimethyl amino propyl amine (DMAPA), methyl myristate, and MeCl in this example. The esterquat will be referred to as “C14 DMAPA MeCl Esterquat.”

About 10.2 grams of DMAPA, about 26.4 grams of C-50 methyl myristate and about 0.388 grams of a 25% solution of sodium methoxide (NaOMe) in methanol (MeOH) were added to a flask equipped with a Dean Stark trap, temperature gauge, and stirring capability. The mixture was heated to 135° C. and then about 5 additional cubic centimeters of methyl myristate was added for fluidization. After approximately four hours the final temperature was about 160° C. and about 5 cubic centimeters of distillate was collected. A small sample was retrieved for analysis by NMR. About 0.010 milligrams of the sample was diluted into about 400 microliters of deuterated chloroform for NMR analysis. The reaction was then deemed nearly complete. The reaction product was an esteramine, which is referred to as C14 DMAPA Esteramine.

About 80 grams of C14 DMAPA Esteramine suspended in a 50% volume/volume mixture of isopropyl alcohol in toluene was then charged to a Parr reactor. The reactor was sealed and flushed several times with nitrogen while stirring. Then the reaction mixture was cooled to about 10° C. with ice water and 15.5 grams of MeCl was admitted to the reactor. The pressure was increased to 80 psid with nitrogen and the reactor was heated to about 90° C. for approximately 2.5 hours. The reaction mixture was allowed to cool gradually overnight with stirring. The liquid content was concentrated on a rotary evaporator until most of the solvent was removed, but the residue was still liquid. The concentrated solution was then slowly (in a thin stream) and under vigorous stirring, poured into about 1 liter of acetone. The C14 DMAPA MeCl Esterquat would precipitate after a few minutes as a white to off-white powder. The acetone suspension was stirred for another 30 minutes with the addition of more acetone if needed to keep fluidity, and finally filtered. The filter cake was pressed to remove most of the solvent and the product was then broken up and transferred to a baking dish to air dry.

### Example 3

### Preparation of a Second Comparative Esterquat from Hydrogenated Coconut Oil and Dimethyl Amino Propyl Amine

Another comparative esterquat was prepared from dimethyl amino propyl amine

(DMAPA), hydrogenated coconut oil, and DMS in this example. The esterquat will be referred to as “Hydrococo DMAPA DMS Esterquat.”

About 620.0 grams of hydrogenated coconut oil was added to a 4-liter reactor equipped with a temperature gauge, pressure gauge, and stirring. About 0.31 grams of sodium borohydride (NaBH₄) was then added to the reactor. Next, about 615.8 grams of this mixture was charged to a similar flask described in Example 2, with the addition of about 2.1 grams of additional hydrogenated coconut oil. About 283.7 grams of DMAPA was added to this mixture, and then the reaction mixture was heated and the temperature and pressure were monitored. The reaction mixture was heated to about 165° C. at a pressure of about 14 psi. The reaction was allowed to stir overnight. The reaction mixture was then cooled to 60° C. and collected. A free amine titration showed that the reaction was complete. The result is an esteramine, which can be referred to Hydrococo DMAPA Esteramine.

About 95.0 grams of Hydrococo DMAPA Esteramine obtained above was added to an appropriate reaction vessel equipped with a temperature gauge, pressure gauge, condenser, and stirring ability. This was heated to 56.1° C., and then about 36.1 grams of DMS was added. The reaction mixture was heated to 80.9° C. and then about 14.5 grams of isopropyl alcohol was added. The reaction mixture was allowed to cool to 70.6° C., and an additional 14.5 grams of isopropyl alcohol was added. Titration with perchloric acid showed the reaction was complete. The product was Hydrococo DMAPA DMS Esterquat.

### Example 4

### Preparation and Comparative Study of Pesticide Compositions Comprising C14 DMEA MeCl Esterguat and Hydrococo DMAPA DMS Esterguat

A glyphosate formulation comprising the C14 DMEA MeCl Esterquat was made by: (1) mixing about 83.06 grams of an aqueous solution of potassium glyphosate (47.8% acid equivalent) with 11.94 grams of water; and (2) adding about 5.0 grams of the C14 DMEA MeCl Esterquat produced above (about 60.14% active) dropwise to the glyphosate solution with stirring. The result was a formulation that contained about 3.0 wt % active C14 DMEA MeCl Esterquat and about 540 g a.e./l (grams of acid equivalent per liter) of glyphosate.

A glyphosate formulation comprising the Hydrococo DMAPA DMS Esterquat was made by: (1) mixing 85.69 grams of an aqueous solution of potassium glyphosate (47.8% acid equivalent) with 12.53 grams of water; and (2) adding about 5.15 grams of the Hydrococo DMAPA DMS Esterquat produced above (about 85.0% active) was added dropwise to the glyphosate solution with stirring. The result was a formulation that contains about 4.25 wt % active Hydrococo DMAPA DMS Esterquat and 540 g a.e./l of glyphosate.

Field trials were performed to evaluate the phytotoxicity enhancement of various versions of esterquats. Samples of the formulations made as described above were applied at two application rates, 90% and 45% of the label rate of RoundUp® Original Max available from Monsanto Company, St. Louis, Mo. RoundUp® Original Max was also used at 45% and 90% of the label rate. For example, if the RoundUp® Original Max label says to use 32 oz. of product per acre, then each of the formulations made as described above and the RoundUp® Original Max was used at 90%×32=28.8 oz./acre and at 45%×32=14.4 oz/acre. In this manner, the quantity of glyphosate spread was equivalent in each comparison, and only the amount and type of surfactant varied.

RoundUp® Original Max contains about 540 g a.e./l of the potassium salt of glyphosate. The actual label rate of RoundUp® Original Max depends on the species of plant one is trying to kill. Different weeds have different susceptibilities to glyphosate, and are required to be treated with different amount of glyphosate. RoundUp® Original Max contains about 8-10% of a blend of surfactants. The precise identity of the surfactants has not been disclosed. Regardless of what surfactant is actually used in the RoundUp® Original Max, the purpose of these experiments was to show that the C14 DMEA MeCl Esterquat of the present technology outperforms what is accepted as the industry standard.

Eight plant species were selected for the study. They include (1) Barnyardgrass, (2) Redroot pigweed, (3) Morning glory ivyleaf, (4) Sicklepod, (5) Panicum, (6) Crabgrass, (7) Velvetleaf, and (8) Sunflower. The tests were performed in a randomized complete block design with 5 replicates of each species of plant. Plants were grown in square plastic pots, 3.75 inches×3.75 inches and 3.125 inches deep. Prior to treatment, 5 replicate pots were indiscriminately selected for each treatment and plant species. Treatments were applied as foliar applications. Treatments were applied with a hand pump sprayer equipped with 1 nozzle calibrated to deliver 15 gallons per acre. All spraying tests included a set of 5 untreated control plants from each species.

The data from the field trials described above using the C14 DMEA MeCl Esterquat of the present technology and the comparative Hydrococo DMAPA DMS Esterquat are included in Table 1 below in comparison to the field trial results using RoundUp® Original Max.

TABLE 1

| | Sum of % kill of all | Sum of % kill of all |
|---|---|---|
| | 8 species at low | 8 species at high |
| Agent Applied | (45%) application rate | (90%) application rate |
| RoundUp ® | 598 | 690 |
| Original Max | | |
| C14 DMEA MeCl | 705 | 750 |
| Esterquat | | |
| Composition | | |
| Hydrococo | 681 | 734 |
| DMAPA DMS | | |
| Esterquat | | |
| Composition | | |

It should be noted that the surfactant loading for the DMAPA esterquat in the pesticide composition tested was about 4.25% by weight while the loading for the DMEA esterquat was only about 3.07% by weight. However, the pesticide composition containing the DMEA esterquat of the present technology performs substantially better than that containing the DMAPA esterquat. The breakdown of the sum of percentage of kill (% kill) by species at the high (90%) application rate is shown in Table 2 below:

TABLE 2

| | RoundUp ® | C14 DMEA | Hydrococo |
|---|---|---|---|
| | Original | MeCl Esterquat | DMAPA DMS |
| Species | Max (% kill) | (% kill) | Esterquat (% kill) |
| Barnyardgrass | 91 | 97 | 87 |
| Redroot pigweed | 83 | 97 | 88 |
| Morning glory, | 67 | 84 | 90 |
| ivyleaf | | | |
| Sicklepod | 60 | 76 | 74 |
| Panicum, fall | 94 | 97 | 96 |
| Crabgrass | 98 | 100 | 99 |
| Velvetleaf | 97 | 99 | 100 |
| Sunflower | 100 | 100 | 100 |

The breakdown of the sum of percentage of kill (% kill) by species at the low (45%) application rate are shown in Table 3 below.

TABLE 3

| | RoundUp ® | C14 DMEA | Hydrococo |
|---|---|---|---|
| | Original | MeCl Esterquat | DMAPA DMS |
| Species | Max (% kill) | (% kill) | Esterquat (% kill) |
| Barnyardgrass | 85 | 94 | 98 |
| Redroot pigweed | 67 | 85 | 96 |
| Morning glory, | 46 | 59 | 66 |
| ivyleaf | | | |
| Sicklepod | 22 | 72 | 35 |
| Panicum, fall | 95 | 95 | 92 |
| Crabgrass | 92 | 100 | 96 |
| Velvetleaf | 91 | 100 | 98 |
| Sunflower | 100 | 100 | 100 |

These results show that the formulation containing C14 DMEA MeCl Esterquat of the present technology is substantially more effective at lower loadings than the current industry standard, RoundUp® Original Max and than the formulation containing Hydrococo DMAPA DMS Esterquat, when used with the potassium salt of glyphosate.

### Example 5

### Comparative Eye Irritation Tests

Samples of the pesticide formulation containing C14 DMEA MeCl Esterquat and potassium glyphosate as described in Example 4 above were sent to Tox Monitor Labs, Oak Park, Ill., for eye irritation tests.

The eye irritation study involved in this example is a screening test, and uses 3 instead of 6 animals as in a full study. The screening test is normally used to screen several products in order to select one or two most desirable ones. It is cost effective and uses fewer animals. The study of the present example used the following protocol:

### FHSA/CPSC Design, 16 CFR 1500; Primary Eye Irritation (Modified);

### FHSA=Federal Hazardous Substances Act

### CPSC=Consumer Product Safety Commission CFR=Code of Federal Register

Briefly, in the screening test of this example, a drop of the glyphosate formulation was placed in rabbits' eyes and the number of animals that experience eye irritation as well as the time it takes for the irritation to clear up and return to normal is recorded. “Tentative Ratings” based on Draize (scale used for eye irritation with points that may range from 0-110) is as follow:

| | | |
|---|---|---|
| 0.0-0.5 | points | Non-irritating |
| 0.5-2.5 | pts. | Practically non-irritating |
| 2.5-15 | pts. | Minimally irritating |
| 15-25 | pts. | Mildly irritating |
| 25-50 | pts. | Moderately irritating |
| 50-80 | pts. | Severely irritating |
| 80-110 | pts. | Extremely irritating to Corrosive |

The results of the eye irritation tests of the samples of the pesticide formulation containing C14 DMEA MeCl Esterquat of the present technology are shown in Table 4 below in comparison to the test results of RoundUp® Weather Max and RoundUp® Original Max, both available from Monsanto Company, St. Louis, Mo.

TABLE 4

| | Irritation | Time for irritation | |
|---|---|---|---|
| Formulation | Score/110 | to clear. | |
| RoundUp ® Weather Max | 25/110 | 7 | days |
| RoundUp ® Original Max | 17/110 | 7 | days |
| C14 DMEA MeCl Esterquat | 7/110 | 48 | hours |

The results show that the pesticide composition of the present technology tested in this example is less irritating than the commercially available RoundUp® Weather Max and RoundUp® Original Max pesticide products.

### Example 6

### Warm and Cold Temperature Stability Studies of the C14 DMEA MeCl Esterquat

A series of 50.0 gram samples of glyphosate concentrate were made using the C14 DMEA MeCl Esterquat made in Example 1 and a variety of salts of glyphosate. These samples were tested for warm and cold temperature stability as follows:

For warm temperature stability, a 50.0 gram sample of a glyphosate concentrate formulation was placed in an oven whose temperature was about 50° C. and allowed to sit in the oven for about 4 weeks. Samples that did not separate or have substantial change in their optical clarity at all over that time period were deemed to be warm temperature stable.

For cold temperature stability, a 50.0 gram sample of a glyphosate concentrate formulation was placed in a refrigerator whose temperature was about 2° C. and allowed to sit in the refrigerator for about 4 weeks. Samples that did not separate or have precipitates in them were deemed stable. If a sample was frozen, it was then removed from the refrigerator and allowed to equilibrate to room temperature, about 21-24° C. Upon equilibration of the temperature of the samples, if the sample thawed such that no separation or substantial change in the optical clarity of the sample occurred, then it was also deemed to be cold temperature stable.

The formulations used in the warm and cold temperature stability experiments of this example are prepared as follows:

Concentrate Formulation 1: About 41.7 grams of a solution of the potassium salt of glyphosate that was 47.8% by weight acid equivalent (a.e.) of glyphosate and about 2.8 grams of deionized water were added to a 4-ounce jar. Then, about 4.0 grams of a solution, which was about 65% by weight of the C14 DMEA MeCl Esterquat and 45% by weight of propylene glycol, was mixed with about 1.5 grams of glycerol, and the entire mixture was slowly added with stirring to the jar. The resulting solution was a clear concentrate potassium glyphosate formulation that contains about 540 g a.e./l (grams of acid equivalent per liter) of glyphosate. The test results showed that this concentrate formulation was warm and cold temperature stable.

Concentrate Formulation 2: About 42.5 grams of a solution of the dimethyl ammonium salt of glyphosate that was 47.05% by weight acid equivalent (a.e.) of glyphosate and about 2.0 grams of deionized water were added in a 4-ounce jar. Then, about 4.0 grams of a solution, which was about 65% by weight of the C14 DMEA MeCl Esterquat and 45% by weight of propylene glycol, was mixed with about 1.5 grams of glycerol, and the entire mixture was slowly added with stirring to the jar. The resulting solution was a clear concentrate dimethyl ammonium glyphosate formulation that contains about 480 g a.e./l of glyphosate. The test results showed that this concentrate formulation was warm and cold temperature stable.

Concentrate Formulation 3: About 32.3 grams of a solution of the isopropyl ammonium salt of glyphosate that was 46.5% by weight acid equivalent (a.e.) of glyphosate and about 10.7 grams of deionized water were added to a 4-ounce jar. Then, about 4.0 grams of a solution, which was about 65% by weight of the C14 DMEA MeCl Esterquat and 45% by weight of propylene glycol, was mixed with about 3.0 grams of glycerol, and the entire mixture was slowly added with stirring to the jar. The resulting solution was a clear concentrate isopropyl ammonium glyphosate formulation that contains about 360 g a.e./l of glyphosate. The test results showed that this concentrate formulation was warm and cold temperature stable.

### Example 7

### Preparation and Comparative Study of Pesticide Compositions Comprising the C14 DMEA MeCl Esterquat and the C14 DMAPA MeCl Esterquat

Field Trials were performed to evaluate the phytotoxicity enhancement of the C14 DMEA MeCl Esterquat and the C14 DMAPA MeCl Esterquat produced in Examples 1 and 2.

The C14 DMEA MeCl Esterquat formulation was prepared as follows: About 32.3 grams of a solution of the isopropyl ammonium salt of glyphosate, which was about 46.5% by weight acid equivalent (a.e.) of glyphosate and about 6.2 grams of deionized water, were added in a 4-ounce jar. Then, about 11.5 grams of a solution, which contained about 65% by weight of the C14 DMEA MeCl Esterquat and 45% by weight of propylene glycol, was slowly added to the jar with stirring. The resulting solution was an isopropyl ammonium glyphosate formulation that contained about 360 g a.e./l (grams of acid equivalent per liter) of glyphosate and 15% by weight of the C14 DMEA MeCl Esterquat.

The C14 DMAPA MeCl Esterquat formulation was prepared as follows: About 32.3 grams of a solution of the isopropyl ammonium salt of glyphosate, which was about 46.5% by weight acid equivalent (a.e.) of glyphosate and about 6.2 grams of deionized water, were added in a 4-ounce jar. Then, about 7.5 grams of the C14 DMAPA MeCl Esterquat and about 4 grams of propylene glycol were slowly added to the jar with stirring. The resulting solution was an isopropyl ammonium glyphosate formulation that contained about 360 g a.e./l of glyphosate and about 15% by weight of the C14 DMEA MeCl Esterquat.

Samples of the formulations as made above were applied to subject plants at two application rates, 90% and 45% of the label rate of RoundUp® Ultra, available from Monsanto Company, St. Louis, Mo. RoundUp® Ultra contains about 360 g a.e./l of isopropyl ammonium glyphosate salt and about 15% by weight of a blend of surfactants. The precise identity of the surfactants has not been disclosed.

Eight plant species were selected for the study. They include (1) Bamyardgrass, (2) Redroot pigweed, (3) Morning glory ivyleaf, (4) Sicklepod, (5) Panicum, (6) Crabgrass, (7) Velvetleaf, and (8) Sunflower. The tests were performed in a randomized complete block design with 5 replicates of each species of plant. Plants were grown in square plastic pots, 3.75 inches×3.75 inches and 3.125 inches deep. Prior to treatment, 5 replicate pots were indiscriminately selected for each treatment and plant species. Treatments were applied as foliar applications with a hand pump sprayer equipped with 1 nozzle calibrated to deliver 15 gallons per acre. All spraying tests included a set of 5 untreated control plants from each species.

The data from the field trials described above using the formulations containing the C14 DMEA MeCl Esterquat of the present technology and the comparative C14 DMAPA MeCl Esterquat are included in the table below, and compared to the field trial results using RoundUp® Ultra.

TABLE 5

| | Sum of % kill of all | Sum of % kill of all |
|---|---|---|
| | 8 species at low | 8 species at high |
| Agent Applied | (45%) application rate | (90%) application rate |
| RoundUp ® | 648 | 757 |
| Ultra | | |
| C14 DMEA MeCl | 652 | 747 |
| Esterquat | | |
| C14 DMAPA MeCl | 660 | 708 |
| Esterquat | | |

The breakdown of the sum of percentage of kill (% kill) by species at the high (90%) application rate is shown in Table 6 below:

TABLE 6

| | | C14 DMEA | C14 DMAPA |
|---|---|---|---|
| | RoundUp ® | MeCl | MeCl |
| Species | Ultra | Esterquat | Esterquat |
| Barnyardgrass | 100 | 100 | 100 |
| Redroot pigweed | 100 | 100 | 100 |
| Morning glory, | 88 | 87 | 84 |
| ivyleaf | | | |
| Sicklepod | 72 | 62 | 33 |
| Panicum, fall | 100 | 100 | 95 |
| Crabgrass | 100 | 100 | 100 |
| Velvetleaf | 97 | 98 | 96 |
| Sunflower | 100 | 100 | 100 |

The breakdown of the sum of percentage of kill (% kill) by species at the low (45%) application rate are shown in Table 7 below:

TABLE 7

| | | C14 DMEA | C14 DMAPA |
|---|---|---|---|
| | RoundUp ® | MeCl | MeCl |
| Species | Ultra | Esterquat | Esterquat |
| Barnyardgrass | 98 | 96 | 99 |
| Redroot pigweed | 100 | 100 | 100 |
| Morning glory, | 28 | 25 | 53 |
| ivyleaf | | | |
| Sicklepod | 30 | 37 | 22 |
| Panicum, fall | 99 | 97 | 90 |
| Crabgrass | 99 | 100 | 100 |
| Velvetleaf | 98 | 98 | 96 |
| Sunflower | 96 | 99 | 100 |

The results of the greenhouse trials show that the C14 DMEA MeCl Esterquat of the present technology is comparable to the industry standard and the C14 DMAPA MeCl Esterquat when used with the IPA salt of glyphosate.

### Example 8

### Surface Tension Comparative Study of the C14 DMEA MeCl Esterguat and the C14 DMAPA MeCl Esterquat

The surface tension of a solution can give important information about its behavior as a surfactant. Measuring the surface tension of a series of aqueous solutions of a molecule and plotting the measured surface tension results versus the logarithm of the concentrations of the series of aqueous solutions yields a plot known as a Gibbs isotherm. From the Gibbs isotherm, one can obtain the critical micelle concentration (CMC) of a surfactant as well as the surface tension at the CMC, two parameters that can indicate the behavior of a surfactant.

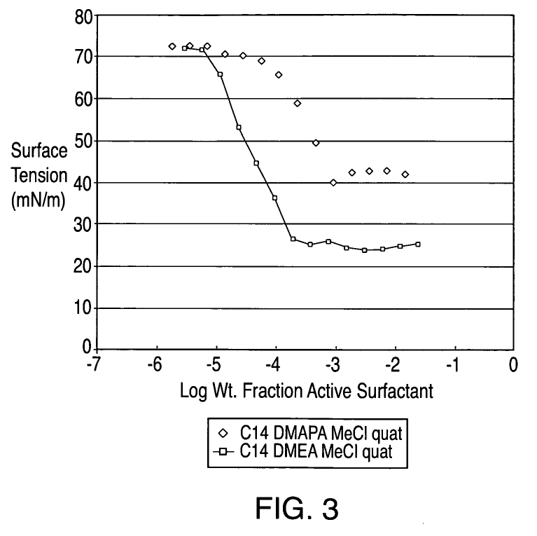

The surface tensions of solutions of the C14 DMEA MeCl Esterquat of the present technology and the comparative C14 DMAPA MeCl X-1 were measured using a Kibron μTrough S instrument available from Kibron Inc., Helsinki, Finland. For each molecule studied, 14 solutions were prepared so that each solution was half the concentration of the previous solution. Another solution that consisted of only deionized water was used as a reference. Therefore, a total of 15 solutions were studied for each molecule. The surface tensions were then plotted as a function of the log of the concentration of the solution for each the C14 DMEA MeCl Esterquat and the C14 DMAPA MeCl Esterquat. The Gibbs Isotherm plots for the C14 DMAPA MeCl Esterquat and the C14 DMEA MeCl Esterquat are shown in FIG. 3.

The plots show that the C14 DMEA MeCl Esterquat of the present technology exhibited lower surface tension than expected. The C14 DMAPA MeCl Esterquat exhibited similar behavior but to a lesser extent. The results show that the C14 DMEA Esterquat of the present technology had a lower critical micelle concentration and a lower surface tension at the critical micelle concentration than the C14 DMAPA MeCl Esterquat. This further demonstrates that the C14 DMAPA MeCl Esterquat of the present technology had higher surface activity and was a stronger surfactant than the C14 DMAPA MeCl Esterquat.

### Example 9

### Preparation of a Wettable Powder Containing Chlorothalonil (90%) and C14 DMEA MeCl Esterquat

A sample of a Chlorothanlonil (90 weight percent) wettable powder was prepared by combining 92.8 grams of chlorothalonil active ingredient (technical grade) with 7.2 grams of C14 DMEA MeCl Esterquat and milling this mixture to a particle size of approximately 4 to 7 micrometers. The wetting of this mixture was tested by adding 5.0 grams of this milled mixture at once to 100 mL of test water (342 ppm standard water) in a 250 mL beaker, and the wetting time was determined to be instantaneous. Next, the percent suspensibility of this milled mixture was tested by diluting 4.0 grams of the mixture in 50 to 60 mL of test water. This solution was mixed for 2 minutes, and then transferred to a 250 mL mixing cylinder and diluted to the 250 mL mark with additional test water. This solution was allowed to sit undisturbed for 30 minutes. The top 225 mL of the solution is then removed, and the bottom 25 mL was dried. The suspensibility of this mixture was determined to be 72.4%. This mixture was then stored in a 54 degrees Celsius oven for 3 days and determined to be stable. The suspensibility of this mixture was determined to be 49.6%.

### Example 10

### Preparation of a Wettable Powder Containing Chlorothalonil (93.5%) and C14 DMEA MeCl Esterquat

A sample of a Chlorothanlonil (93.5 weight percent) wettable powder was prepared by combining 96.4 grams of chlorothalonil active ingredient (technical grade) with 3.6 grams of C14 DMEA MeCl Esterquat and milling this mixture to a particle size of approximately 4 to 7 micrometers. The wetting of this mixture was tested by adding 5.0 grams of this milled mixture at once to 100 mL of test water (342 ppm standard water) in a 250 mL beaker, and the wetting time was determined to be instantaneous. Next, the percent suspensibility of this milled mixture was tested by diluting 4.0 grams of the mixture in 50 to 60 mL of test water. This solution was mixed for 2 minutes, and then transferred to a 250 mL mixing cylinder and diluted to the 250 mL mark with additional test water. This solution was allowed to sit undisturbed for 30 minutes. The top 225 mL of the solution is then removed, and the bottom 25 mL was dried. The suspensibility of this mixture was determined to be 60.4%. This mixture was then stored in a 54 degrees Celsius oven for 3 days and determined to be stable. The suspensibility of this mixture was determined to be 68.6%.

### Example 11

### Preparation of a Wettable Powder Containing Imidacloprid (70%) and C14 DMEA MeCl Esterquat

A sample of a Imidacloprid (70 weight percent) wettable powder was prepared by combining 73.7 grams of imidacloprid active ingredient (technical grade) with 6 grams of C14 DMEA MeCl Esterquat, 0.5 grams silica, and 19.8 grams of clay, and milling this mixture to a particle size of approximately 5.7 micrometers. The wetting of this mixture was tested by adding 5.0 grams of this milled mixture at once to 100 mL of test water (342 ppm standard water) in a 250 mL beaker, and the wetting time was determined to be 4 seconds. Next, the percent suspensibility of this milled mixture was tested by diluting 4.0 grams of the mixture in 50 to 60 mL of test water. This solution was mixed for 2 minutes, and then transferred to a 250 mL mixing cylinder and diluted to the 250 mL mark with additional test water. This solution was allowed to sit undisturbed for 30 minutes. The top 225 mL of the solution is then removed, and the bottom 25 mL was dried. The suspensibility of this mixture was determined to be 88.7%. This mixture was then stored in a 54 degrees Celsius oven for 2 days and determined to be stable. The suspensibility of this mixture was determined to be 76.3%.

### Example 12

### Preparation of a Suspension Concentrate Containing Chlorothalonil (720 μL) and C14 DMEA MeCl Esterquat

A sample of a Chlorothanlonil (720 g/L) wettable powder was prepared by combining 55 grams of chlorothalonil active ingredient (technical grade) with 3.0 grams of C14 DMEA MeCl Esterquat, 5.0 grams of propylene glycol, 0.15 grams of silicone defoamer, and 26.85 grams of water, and milling this mixture in a bead mill to a particle size of approximately 1.8 micrometers. Then, 10 g rams of a 2% solution of Kelzan/Biocide was added to the mixture, and the mixture was sheared to incorporate the Kelzan/Biocide into the mixture. The wetting of this mixture was tested by adding 5.0 grams of this milled mixture at once to 100 mL of test water (342 ppm standard water) in a 250 mL beaker, and the wetting time was determined to be instantaneous. Next, the percent suspensibility of this milled mixture was tested by diluting 4.0 grams of the mixture in 50 to 60 mL of test water. This solution was mixed for 2 minutes, and then transferred to a 250 mL mixing cylinder and diluted to the 250 mL mark with additional test water. This solution was allowed to sit undisturbed for 30 minutes. The top 225 mL of the solution is then removed, and the bottom 25 mL was dried. The suspensibility of this mixture was determined to be 99.1%. This mixture was then stored in a 54 degrees C. oven for 3 days. Some slight separation occurred. Upon remixing, the suspensibility of this mixture was determined to be 95.1%.

A summary of the results of the wetting and percent suspensibility for Examples 9-12 are shown in Table 8 below:

TABLE 8
Example 9: Chlorothalonil 90 WP

| Chlorothalonil Technical | 92.8 | |
|---|---|---|
| Surfactant | 7.2 | |
| | 100 | wt % |
| Particle Size, mean | 7.3 | μm |
| Suspensibility | | |
| Initial | 72.4% | |
| 3 days, 54° C. | 49.6% | |
| Wettability | 2 | Sec. |

Example 10: Chlorothalonil 93.5 WP

| Chlorothalonil Technical | 96.4 | |
|---|---|---|
| Surfactant | 3.6 | |
| | 100 | wt % |
| Particle Size, mean | 4.6 | μm |
| Suspensibility | | |
| Initial | 60.4% | |
| 3 days, 54° C. | 68.6% | |
| Wettability | <1 | Sec. |

Example 11: Imidacloprid 70 WP

| Imidacloprid Technical | 73.7 | |
|---|---|---|
| Surfactant | 6.0 | |
| Silica | 0.5 | |
| Clay | 19.8 | |
| | 100 | wt % |
| Particle Size, mean | 5.7 | μm |
| Suspensibility | | |
| Initial | 88.7% | |
| 2 days, 54° C. | 76.3% | |
| Wettability | 4 | Sec. |

Example 12: Chlorothalonil 720 g/L

| Chlorothalonil Technical | 55.0 | |
|---|---|---|
| Surfactant | 3.0 | |
| Propylene Glycol | 5.0 | |
| Silicone Defoamer (SAG 30) | 0.15 | |
| 2% Xanthan Gum/biocide Solution | 10.0 | |
| (Kelzan S/Proxel GXL) | | |
| Water, tap | 26.85 | |
| | 100 | wt % |
| Particle Size, mean | 1.8 | μm |

| | |
|---|---|
| Suspensibility | |
| Initial | 99.1% |
| 3 days, 54° C. | 95.1% |

### Example 13

### Preparation of a Emulsifiable Concentrate Containing Tebuconazole and C14 DMEA MeCl Esterquat

A Tebuconazole emulsifiable concentrate was prepared by mixing 45 grams of tebuconazole active ingredient, 189 grams of Hallcomid M-8-10 solvent, 7 grams of DMEA Esterquat, and 7 grams of Toximul 8320, a butyl based block copolymer. This emulsifiable concentrate was tested by adding 5 mL of this emulsifiable concentrate to 95 mL of water (342 ppm WHO standard water). The amount of settling was recorded as a function of time and the results are presented below in Table 9.

### Example 14

### Preparation of a Emulsifiable Concentrate Containing Chlorpyrifos and C14 DMEA MeCl Esterquat

A Chlorpyrifos emulsifiable concentrate was prepared by mixing 90 grams of chlorpyrifos active ingredient, 189 grams of Hallcomid M-8-10 solvent, 7 grams of DMEA Esterquat, and 4.3 grams of Toximul 8320, 2.5 grams of Ninex MT-630 (fatty acid ethoxylate), and 0.4 grams of Ninate 60E (calcium dodecyl benzene sulfonate). This emulsifiable concentrate was tested by adding 5 mL of this emulsifiable concentrate to 95 mL of water (342 ppm WHO standard water). The amount of settling was recorded as a function of time and the results are presented below in Table 9.

### Example 15

### Preparation of a Emulsifiable Concentrate Containing Bifenthrin and C14 DMEA MeCl Esterquat

A Bifenthrin emulsifiable concentrate was prepared by mixing 45 grams of bifenthrin active ingredient, 189 grams of Hallcomid M-8-10 solvent, 7 grams of DMEA Esterquat, and 4.3 grams of Toximul 8320, 2.5 grams of Ninex MT-630 (fatty acid ethoxylate), and 0.4 grams of Ninate 60E (calcium dodecyl benzene sulfonate). This emulsifiable concentrate was tested by adding 5 mL of this emulsifiable concentrate to 95 mL of water (342 ppm WHO standard water). The amount of settling was recorded as a function of time and the results are presented below in Table 9. For Example 15, it should be noted that although there was an equal amount of cream, the formulation with the DMEA esterquat yielded a richer and creamier emulsion, indicating that over even longer times, this formulation would be more stable.

For Examples 13-15, a comparative example was prepared in the same way replacing the DMEA esterquat with Ninate 60E, a calcium dodecylbenzene sulfonate salt (an anionic surfactant). The data are summarized in Table 9 below. This data shows that a DMEA esterquat described herein can be used in place of anionic emulsifiers typically used in emulsifiable concentrate formulations.

TABLE 9

| | Tebuconazole EC # | |
|---|---|---|
| | Tebuconazole | Tebuconazole |
| | EC #1, 2 lbs/gal. | EC #2, 2 lbs/gal. |
| Tebuconazole Active (g) | 45 | 45 |
| Hallcomid M-8-10 (g) | 189 | 189 |
| Toximul 8320 (g) | 6.9 | 6.9 |
| Ninate 60E (g) | 4.6 | 0 |
| C12/14 DMEA esterquat (g) | 0 | 4.6 |
| Initial Bloom | Excellent | Excellent |

Emulsion Stability

| 30 min stability (mL cream) | 0 | 0 |
|---|---|---|
| 1 hour stability (mL cream) | 0 | 0 |
| 2 hour stability (mL cream) | 0 | 0 |
| | Chlorpyrifos EC # | |
| | Chlorpyrifos | Chlorpyrifos |
| | EC #1, 4 lbs/gal. | EC #2, 4 lbs/gal. |
| Chlorpyrifos Active (g) | 90 | 90 |
| Hallcomid M-8-10 (g) | 189 | 189 |
| Toximul 8320 (g) | 4.3 | 4.3 |
| Ninex MT-630 (g) | 2.5 | 2.5 |
| Ninate 60E (g) | 7.4 | 0.4 |
| C12/14 DMEA esterquat (g) | 0 | 7 |
| Initial Bloom | Fair | Excellent |

Emulsion Stability

| 30 min stability (mL cream) | 0 | 0 |
|---|---|---|
| 1 hour stability (mL cream) | 0 | 0 |
| 2 hour stability (mL cream) | 0 | 2 |
| | Bifenthrin EC # | |
| | Bifenthrin | Bifenthrin |
| | EC 1, 2 lbs/gal. | EC 2, 2 lbs/gal. |
| Bifenthrin Active (g) | 45 | 45 |
| Hallcomid M-8-10 (g) | 189 | 189 |
| Toximul 8320 (g) | 4.3 | 4.3 |
| Ninex MT-630 (g) | 2.5 | 2.5 |
| Ninate 60E (g) | 7.4 | .4 |
| C12/14 DMEA esterquat (g) | 0 | 7 |
| Initial Bloom | Excellent | Excellent |

Emulsion Stability

| | | |
|---|---|---|
| 30 min stability (mL cream) | 0 | 0 |
| 1 hour stability (mL cream) | 0 | 2 |
| 2 hour stability (mL cream) | 5 | 3 |

The present technology is now described in such full, clear, concise and exact terms as to enable any person skilled in the art to which it pertains, to practice the same. It is to be understood that the foregoing describes preferred embodiments of the invention and that modifications may be made therein without departing from the spirit or scope of the present technology as set forth in the appended claims.

What is claimed is:

1. A pesticidal composition, comprising:
(i) a pesticide or a mixture of pesticides in a biologically effective amount; and
(ii) at least one adjuvant, dispersant or surfactant comprising at least one dialkyl alkanolamine, derivatives thereof, or combinations thereof in an amount such that the pesticidal composition exhibits an enhanced pesticidal efficacy as compared to a reference pesticidal composition devoid of the dialkyl alkanolamine, derivatives thereof, or combinations thereof, but otherwise having the same components.

2. The composition of claim 1, wherein the composition is selected from the group consisting of an aqueous concentrate, a ready-to-use composition, a wettable powder, a suspension concentrate, an emulsifiable concentrate and a dry powder.

3. The composition of claim 1, wherein the pesticide is selected from the group consisting of an herbicide, fungicide and insecticide.

4. The composition of claim 1, wherein the dialkyl alkanolamine is dimethyl ethanolamine, and the derivatives thereof are selected from the group consisting of dimethyl alkyl ethanol quaternary ammonium compounds, esteramines derived from dimethyl ethanolamine and (a) carboxylic acids, (b) derivatives thereof or (c) mixtures thereof, esterquats derived from said esteramines, and combinations thereof.

5. The composition of claim 4, wherein the dialkyl alkanolamine derivative comprises a dimethyl alkyl ethanol quaternary ammonium compound, an esterquat derived from dimethyl ethanolamine, or a combination thereof.

6. The composition of claim 4, wherein the carboxylic acid is a fatty acid having a saturated or unsaturated hydrocarbon chain having from about 5 to about 23 carbon atoms.

7. The composition of claim 5, wherein the dimethyl alkyl ethanol quaternary ammonium compound or the esterquat is derived from a quaternizing agent containing from about 1 to about 23 carbon atoms.

8. The composition of claim 1, wherein the adjuvant, dispersant or surfactant further comprises one or more components different than the dialkyl alkanolamine, derivatives thereof, or combinations thereof.

9. The composition of claim 8, wherein the components are selected from the group consisting of cationic, anionic, nonionic, and amphoteric surfactants, and combinations thereof.

10. The composition of claim 8, wherein the components are selected from the group consisting of amine oxides, phosphate esters, ether sulfates, alkyl amine ethoxylates, alkyl poly glycosides, alcohol ethoxylates, alkyl quaternary ammonium surfactants, carboxylic acids, ammonium sulfates, ether amine ethoxylates, alkyl betaines, butyl based block copolymer, fatty acid ethoxylates, calcium dodecyl benzene sulfonate, and combinations thereof.

11. The composition of claim 1, further comprising one or more additives.

12. The composition of claim 11, wherein the additives are selected from the group consisting of inert fillers, processing aids, freeze recovery agents, anti-settling agents and viscosity modifiers.

13. The composition of claim 1, wherein the pesticide is selected from the group consisting of glyphosate, chlorothalonil, imidacloprid, tebuconazole, chlorpyrifos, bifenthrin or a derivative thereof, or a mixture thereof.

14. The composition of claim 13, wherein the glyphosate is substantially in the form of a potassium, monoammonium, diammonium, dimethyl ammonium, isopropylammonium, trimethylsulfonium or monoethanolamine salt, or a mixture thereof.

15. The composition of claim 1, wherein the composition is an aqueous concentrate having a cloud point of at least about 50° C. and a crystallization point not greater than about 0° C.

16. The composition of claim 1, wherein the composition is an aqueous concentrate wherein the concentration of the dialkyl alkanolamine, derivatives thereof, or combinations thereof is at least about 0.5% by weight based on the total weight of the composition.

17. The composition of claim 1 wherein the composition is a wettable powder.

18. The composition of claim 17 wherein the wettable powder comprises:
from about 20 to about 90 weight percent of the pesticide or mixture of pesticides; and
from about 1 to about 20 weight percent of the dispersant.

19. The composition of claim 1 wherein the composition is a suspension concentrate.

20. The composition of claim 19 wherein the suspension concentrate comprises:
from about 20 to about 60 weight percent of the pesticide or mixture of pesticides;
from about 1 to about 20 weight percent of the dispersant; and
from about 20 to about 79 weight percent of water.

21. The composition of claim 1 wherein the composition is an emulsifiable concentrate.

22. The composition of claim 21 wherein the emulsifiable concentrate comprises:
from about 15 to about 60 weight percent of the pesticide or mixture of pesticides;
from about 1 to about 20 weight percent of the surfactant; and
from about 20 to about 84 weight percent of solvent.

23. The composition of claim 1 wherein the composition is a dry powder.

24. The composition of claim 1 wherein the composition is a ready-to-use composition.

25. The composition of claim 1, wherein the pesticide comprises glyphosate.

26. The composition of claim 25, wherein glyphosate is substantially in the form of a potassium, monoammonium, diammonium, dimethyl ammonium, isopropylammonium, trimethylsulfonium or monoethanolamine salt, or a mixture thereof.
